(19) United States
(12) Patent Application Publication
(10) Pub. No.: US 2017/0017417 A1
(43) Pub. Date: Jan. 19, 2017

(54) DATA STORAGE DEVICE AND OPERATING METHOD THEREOF

(71) Applicant: SK hynix Inc., Gyeonggi-do (KR)

(72) Inventors: Chol Su CHAE, Gyeonggi-do (KR); Jun Rye RHO, Gyeonggi-do (KR)

(21) Appl. No.: 14/957,291

(22) Filed: Dec. 2, 2015

(30) Foreign Application Priority Data
Jul. 17, 2015 (KR) 10-2015-0101792

(51) Int. Cl. G06F 3/06; G06F 11/10

(52) U.S. Cl. CPC G06F 3/0619; G06F 3/0655; G06F 3/0679; G06F 11/108

(57) ABSTRACT

A data storage device includes a nonvolatile memory apparatus including a page including a plurality of chunk areas respectively corresponding to a plurality of data chunks; and a controller including a memory, and suitable for generating parity data by independently encoding one of the plural data chunk, storing the data chunk in one of the plural chunk areas of the page and storing the parity data in the memory as intermediate parity data.

### CROSS-REFERENCES TO RELATED APPLICATION

The present application claims priority under 35 U.S.C. §119(a) to Korean application number 10-2015-0101792, filed on Jul. 17, 2015, which is incorporated herein by reference in its entirety as set forth in full.

### BACKGROUND

1. Technical Field

Various embodiments relate to a data storage device, and more particularly, to a data storage device that encodes data.

2. Related Art

Data storage devices store data provided by an external device in response to a write request. Data storage devices may also provide stored data to an external device in response to a read request. Examples of external devices that use data storage devices include computers, digital cameras, cellular phones and the like. Data storage devices can be embedded in external devices or fabricated separately and then connected afterwards.

### SUMMARY

A data storage device according to an embodiment of the present invention may include: a nonvolatile memory apparatus including a page including a plurality of chunk areas respectively corresponding to a plurality of data chunks; and a controller including a memory, and suitable for generating parity data by independently encoding one of the data chunk, storing the data chunk in one of the plural chunk areas of the page and storing the parity data in the memory as intermediate parity data.

An operating method of a data storage device including a page including a plurality of chunk areas respectively corresponding to a plurality of data chunks according to an embodiment of the present invention may include: generating parity data by independently encoding one of the plural data chunks; storing the data chunk in one of the plural chunk areas of the page; and storing the parity data in a memory as intermediate parity data.

### BRIEF DESCRIPTION OF THE DRAWINGS

Features, aspects, and embodiments are described in conjunction with the attached drawings, in which:

FIG. 1 is a block diagram Illustrating a data storage device according to an embodiment;

FIG. 2 is a schematic diagram illustrating a page included in a nonvolatile memory device shown in FIG. 1;

FIG. 3 is a block diagram illustrating an example of an encoder shown in FIG. 1;

FIG. 4 is a transaction diagram illustrating an operation of a data storage device shown in FIG. 1;

FIG. 5 is a block diagram illustrating an example of an encoder of FIG. 1;

FIG. 6 is a transaction diagram illustrating an operating method of a data storage device shown in FIG. 1;

FIG. 7 is a block diagram illustrating an example of an encoder shown in FIG. 1;

FIG. 8 is a transaction diagram illustrating an operation of a data storage device shown in FIG. 1;

FIG. 9 is a block diagram illustrating an example of an encoder shown in FIG. 1;

FIG. 10 is a transaction diagram illustrating an operation of a data storage device shown in FIG. 1;

FIG. 11 is a flowchart illustrating an operation of a data storage device according to an embodiment;

FIG. 12 is a block diagram illustrating a solid state drive according to an embodiment; and

FIG. 13 is a block diagram illustrating a data processing system to which a data storage device according to an embodiment has been applied.

### DETAILED DESCRIPTION

Hereinafter, a data storage device and an operating method thereof according to the present invention will be described in detail with reference to the accompanying drawings through an exemplary embodiment.

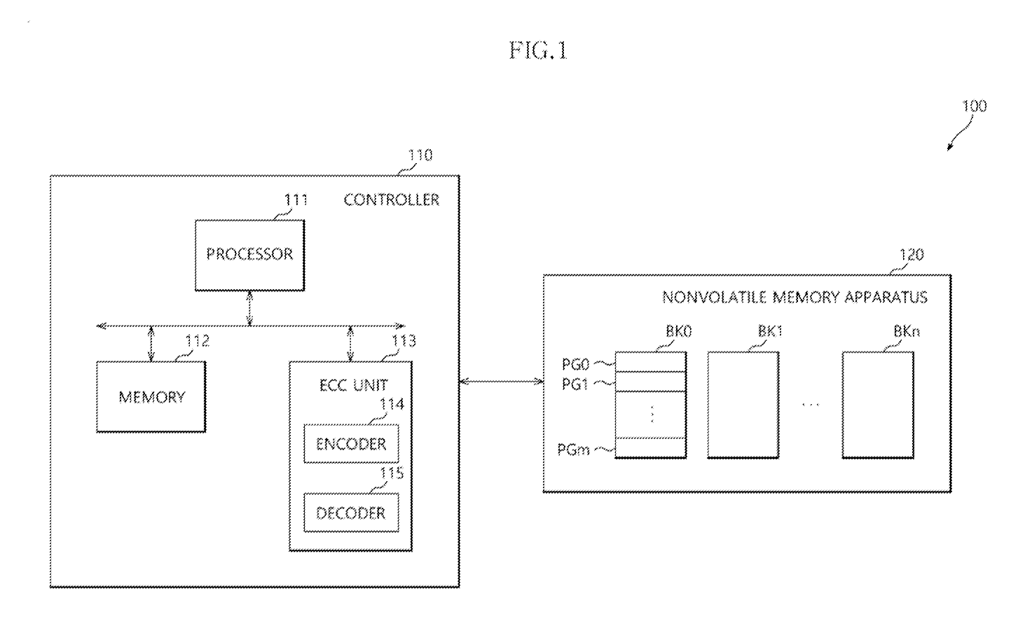

FIG. 1 is a block diagram illustrating a data storage device 100 according to an embodiment.

The data storage device 100 may be configured with a PCMCIA (Personal Computer Memory Card International Association) card, a CF (Compact Flash) card, a smart media card, a memory stick, various multimedia cards such as a MMC, an eMMC, a RS-MMC, and a MMC-micro, an SD (Secure Digital) card such as an SD, a Mini-SD, and a Micro-SD, a UFS (Universal Flash Storage), an SSD and the like.

The data storage device 100 may include a controller 110 and a nonvolatile memory apparatus 120.

The controller 110 may include a processor 111, a memory 112, and an ECC unit 113.

The processor 111 may control general operation of the data storage device 100. The processor 111 may store data in the nonvolatile memory apparatus 120 in response to a write request transmitted from an external device (not illustrated), and read the data stored in the nonvolatile memory apparatus 120 and output the data to the external device in response to a read request transmitted from the external device. The processor 111 may drive firmware for controlling the data storage device 100 on the memory 112.

The memory 112 may store the firmware driven by the processor 111 and various types of data required for the operation of the controller 110. For example, the memory 112 may store intermediate parity data generated in the ECC unit 113. Furthermore, the memory 112 may temporarily store data transmitted between the external device and the nonvolatile memory apparatus 120.

The ECC unit 113 may include an encoder 114 and a decoder 115.

The encoder 114 may encode data to be stored in the nonvolatile memory apparatus 120, thereby generating parity data.

The decoder 115 may decode data, which has been read from the nonvolatile memory apparatus 120, by using parity data for corresponding data, thereby detecting an error included in the read data and correcting the detected error.

The nonvolatile memory apparatus 120 may retain stored data although power is off. The nonvolatile memory apparatus 120 may include a flash memory apparatus such as a NAND flash or a NOR flash, a FeRAM (Ferroelectrics Random Access Memory), a PCRAM (Phase-Change Random Access Memory), a MRAM (Magnetic Random Access Memory), a ReRAM (Resistive Random Access Memory) and the like.

Under the control of the controller 110, the nonvolatile memory apparatus 120 may perform a write operation in order to store data transmitted from the controller 110, and perform a read operation in order to read stored data and transmit the read data to the controller 110. The nonvolatile memory apparatus 120 may store data in a plurality of memory blocks BK0 to BKn. Each of the plurality of memory blocks BK0 to BKn may include a plurality of pages PG0 to PGm.

Among the memory blocks BK0 to BKn, at least one, for example, the memory block BK0 may be used as a buffer. That is, the controller 110 may store data requested to be written from the external device in the memory block BK0 once, and for example, may move the data stored in the memory block BK0 to the memory blocks BK1 to BKn, which are not used as buffers, at an idle time. The memory block BK0 used as the buffer may be configured with an SLC (Single Level Cell) with a high write/read speed, and the memory blocks BK1 to BKn not used as the buffers may be configured with a MLC (Multi Level Cell)/TLC (Triple Level Cell) which have a write/read speed slower than that of the SLC and may support larger storage capacity. However, the present invention is not limited to this particular configuration.

According to an embodiment, the data storage device 100 may include a plurality of nonvolatile memory apparatuses. When the data storage device 100 includes nonvolatile memory apparatuses, the controller 110 may control each of the nonvolatile memory apparatuses, thereby storing data in the nonvolatile memory apparatuses.

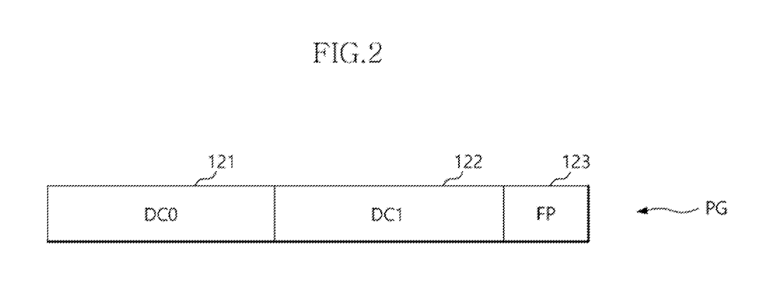

FIG. 2 is a schematic diagram illustrating a page included in the nonvolatile memory device 120 described with reference to FIG. 1.

A page PG may include chunk areas 121 and 122 and a spare area 123. Data chunks DC0 and DC1 may be stored in the chunk areas 121 and 122, respectively, and meta data including information on the data chunks DC0 and DC1, for example, parity data FP may be stored in the spare area 123. The data chunk is a unit of data stored in each of the chunk areas 121 and 122.

FIG. 2 illustrates that the page PG includes two chunk areas 121 and 122; however, the number of chunk areas included in the page PG is not limited thereto. According to an embodiment, assuming that the page has a fixed size, as the number of chunk areas included in the page increases, the size of a data chunk stored in one chunk area may be reduced.

Referring again to FIG. 1, the nonvolatile memory apparatus 120 may independently perform a write operation with respect to each of the chunk areas 121 and 122 through a “partial write Jo operation”. That is, the nonvolatile memory apparatus 120 may store data in each of the chunk areas 121 and 122 through the partial write operation in units of data chunks. The nonvolatile memory apparatus 120 may also Independently perform the partial write operation with respect to the spare area 123.

The configurations of pages PG0 to PGm of the memory block BK0 used as the buffer may be substantially the same as that of the page PG illustrated in FIG. 2. That is, the nonvolatile memory apparatus 120 may store data chunks in the pages PG0 to PGm of the memory block BK0 through the partial write operation. Accordingly, the controller 110 may use the memory block BK0 as the buffer more efficiently.

The encoder 114 may encode the data chunks DC0 and DC1, which are to be stored in each of the chunk areas 121 and 122 of one page PG together, thereby generating final parity data FP. The “together” may indicate that the encoder 114 generates the parity data FP, which is to be stored in the spare area 123, through the encoding all of the data chunks DC0 and DC1, which is to be stored in all of the chunk areas 121 and 122 within the page PG, despite of the partial write operation.

According to the embodiment, even though the data chunks DC0 and DC1 are discontinuously stored in the page PG through the partial write operation while encoded together for the generation of the parity data FP, the controller 110 does not need to maintain the data chunks DC0 and DC1 in the memory 112 until the generation of Jo the final parity data FP.

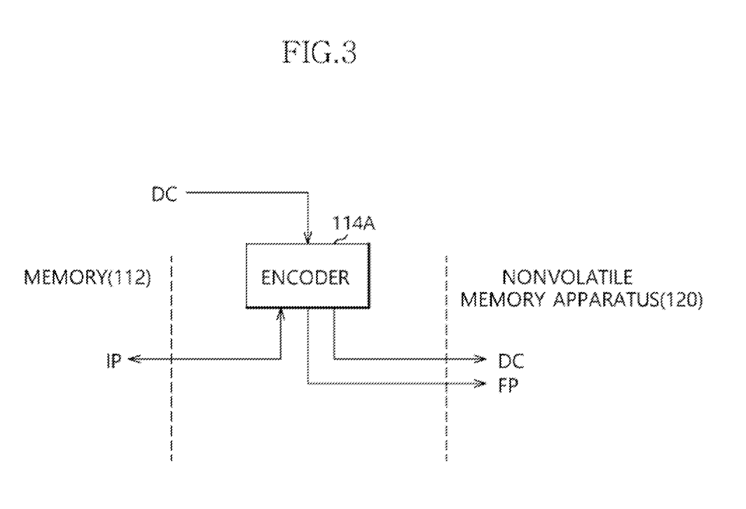

FIG. 3 is a block diagram illustrating an example of the encoder 114A described with reference to FIG. 1.

The encoder 114A may encode the data chunk DC. The encoded data chunk DC may be partially stored in the page PG of the nonvolatile memory apparatus 120 through the partial write operation. The encoder 114A may encode a current data chunk DC with an intermediate parity data IP, which is an encoding result of previously stored data chunks DC in the page PG. When the current data chunk DC is a final data chunk of the page PG, that is, when there is no other following data chunk DC to be encoded, the parity data generated by encoding the current data chunk DC may be stored in the nonvolatile memory apparatus 120 as the final parity data FP. When the current data chunk DC is not the final data chunk of the page PG, the intermediate parity data IP may be updated to reflect the encoding of the current data chunk DC as well as the previous data chunks DC. The updated intermediate parity data IP may be maintained by the memory 112.

The intermediate parity data IP may be loaded from the memory 112 to the encoder 114A when a current data chunk DC is transmitted to the encoder 114A. The encoder 114A may encode the current data chunk DC by using the loaded intermediate parity data IP, which results in the encoding of all the data chunks DC currently to be stored and previously stored in the page PG thereby updating the intermediate parity data IP.

That is, the encoder 114A may encode the discontinuously provided data chunks DC together with each for the single page PG by using the intermediate parity data IP stored in the memory 112 and representing the encoding of the data chunks DC currently stored in the page PG.

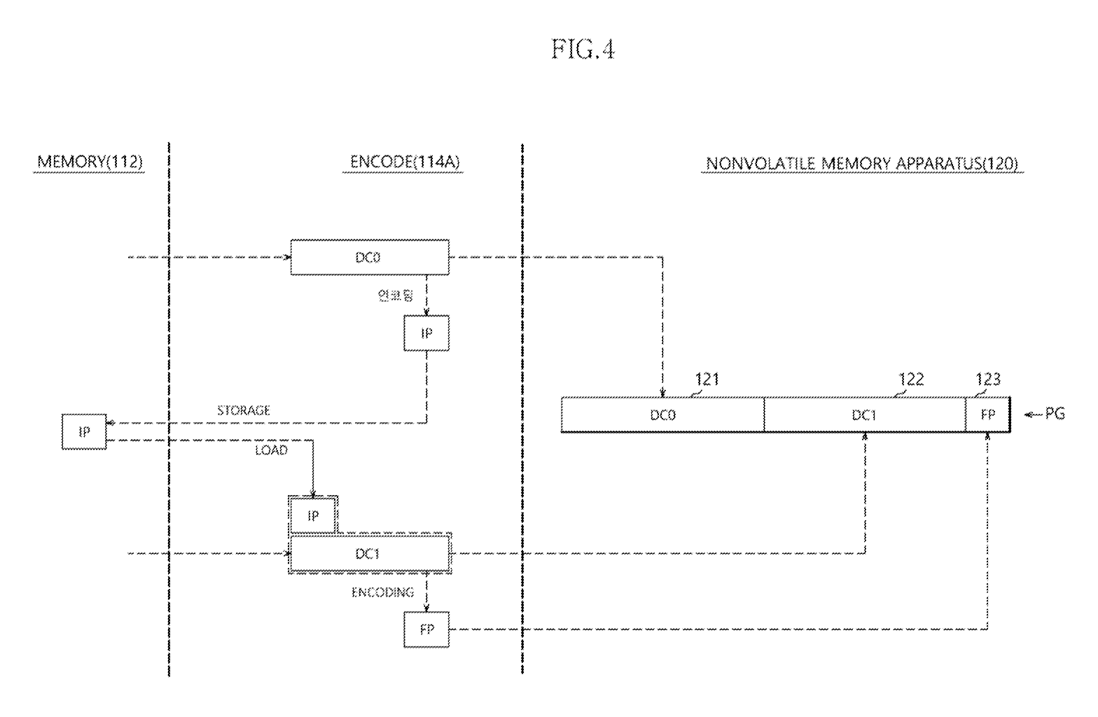

FIG. 4 is a transaction diagram illustrating an operation of the data storage device 100 described with reference to FIG. 1. FIG. 4 illustrates the encoder 114A encoding the data chunks DC0 and DC1, which are to be stored in the chunk areas 121 and 122 of the page PG through the partial write operation, and generating the intermediate parity data IP and the final parity data FP.

The encoder 114A may receive the data chunk DC0 to be stored in the chunk area 121 from the memory 112. The encoder 114A may encode the data chunk DC0, thereby generating the intermediate parity data IP.

The encoded data chunk DC0 may be directly stored in the chunk area 121. The intermediate parity data IP may be stored in the memory 112 until the data chunk DC1 to be encoded together with the data chunk DC0 is inputted to the encoder 114A.

Then, the encoder 114A may receive the data chunk DC1 to be stored in the chunk area 122 from the memory 112. The encoder 114A may encode the data chunk DC1 by using the intermediate parity data IP loaded from the memory 112, thereby generating the final parity data FP for the data chunks DC0 and DC1.

The encoded data chunk DC1 may be stored in the chunk Jo area 122. Since there is no other following data chunk to be encoded together with the data chunks DC0 and DC1, the final parity data FP may be stored in the spare area 123. According to an embodiment, the data chunk DC1 and the final parity data FP may be simultaneously stored in the chunk area 122 and the spare area 123 through the partial write operation.

According to an embodiment, even though the data chunks DC0 and DC1 are discontinuously stored in the page PG through the partial write operation while encoded together for the generation of the parity data FP, the controller 110 needs not maintain the data chunks DC0 and DC1 in the memory 112 until the generation of the final parity data FP. Whenever a data chunk is provided, the controller 110 may immediately encode the data chunk to generate intermediate parity data, store the encoded data chunk in the nonvolatile memory apparatus 120, and store only the intermediate parity data in the memory 112.

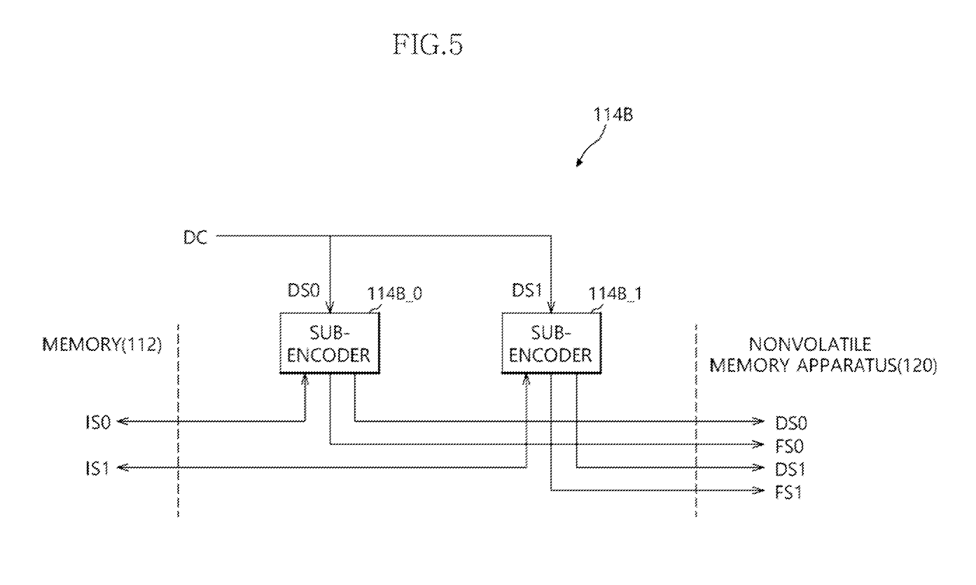

FIG. 5 is a block diagram illustrating an example of the encoder 114B described with reference to FIG. 1.

The encoder 114B may divide a single data chunk into a plurality of data sectors and encode the data chunks for the improvement of error correction capability.

For example, the encoder 114B may divide the data chunk DC into first and second data sectors DS0 to DS1 respectively belonging to first and second sector groups, and encode the first and second data sectors DS0 to DS1 according to the first and second sector groups, thereby respectively generating first and second intermediate parity sectors. The encoder 114B may encode a current first and second data sectors DS0 to DS1 with intermediate parity sectors IS0 and IS1, which is the encoding result of previously stored first and second data sectors DS0 to DS1 in the page PG. The encoded first and second data sectors DS0 to DS1 may be stored in the nonvolatile memory apparatus 120 through the partial write operation. When the data chunk DC is a final data chunk of the page PG, the generated first and second parity sectors may be stored in the nonvolatile memory apparatus 120 as final parity sectors FS0 and FS1. When the data chunk DC is not the final data chunk of the encoding unit, the intermediate parity sectors IS0 and IS1 may be updated to reflect the encoding of the current data chunk DC as well as the previous data chunks DC. The updated intermediate parity sectors IS0 and IS1 may be maintained by the memory 112.

The intermediate parity sectors IS0 and IS1 may be loaded to the encoder 114B from the memory 112 when a current data chunk DC is transmitted to the encoder 114B. The encoder 114B may respectively encode the data sectors DS0 to DS1 of the current data chunk DC by respectively using the loaded intermediate parity sectors IS0 and IS1, which results in the encoding of all the data chunks DC currently to be stored and previously stored in the page PG thereby updating the intermediate parity sectors IS0 and IS1.

The data sectors belonging to the same sector group may be encoded together for corresponding intermediate and final parity Jo sectors while data sectors belonging to different sector groups may not. FIG. 5, for example, illustrates first and second intermediate and final parity sectors IS0 and IS1 and FS0 and FS1 belonging to first and second sector groups for each data chunk DC.

The encoder 114B may include first and second sub-encoders 114B_0 and 114B_1.

The first sub-encoder 114B_0 may encode the first data sector DS0 of the data chunk DC to generate the first intermediate and final parity sectors IS0 and FS0. The generated parity sector may be stored in the memory 112 as the first intermediate parity sector IS0, or may be stored in the nonvolatile memory apparatus 120 as the first final parity sector FS0.

The second sub-encoder 114B_1 may encode the second data sector DS1 of the data chunk DC to generate the second intermediate and final parity sectors IS1 and FS1. The generated parity sector may be stored in the memory 112 as the second intermediate parity sector IS1, or may be stored in the nonvolatile memory apparatus 120 as the second final parity sector FS1.

FIG. 5 illustrates that the encoder 114B includes the two sub-encoders 114B_0 and 114B_1 for dividing a data chunk into two data sectors DS0 and DS1 and respectively encoding the two data sectors DS0 and DS1. According to an embodiment, the number of sub-encoders included in the encoder 114B may be substantially equal or different from the number of data sectors divided from a data chunk. According to an embodiment, the encoder 114B may include a single sub-encoder sequentially encoding the data sectors divided from the data chunk to sequentially generate parity sectors according to sector groups.

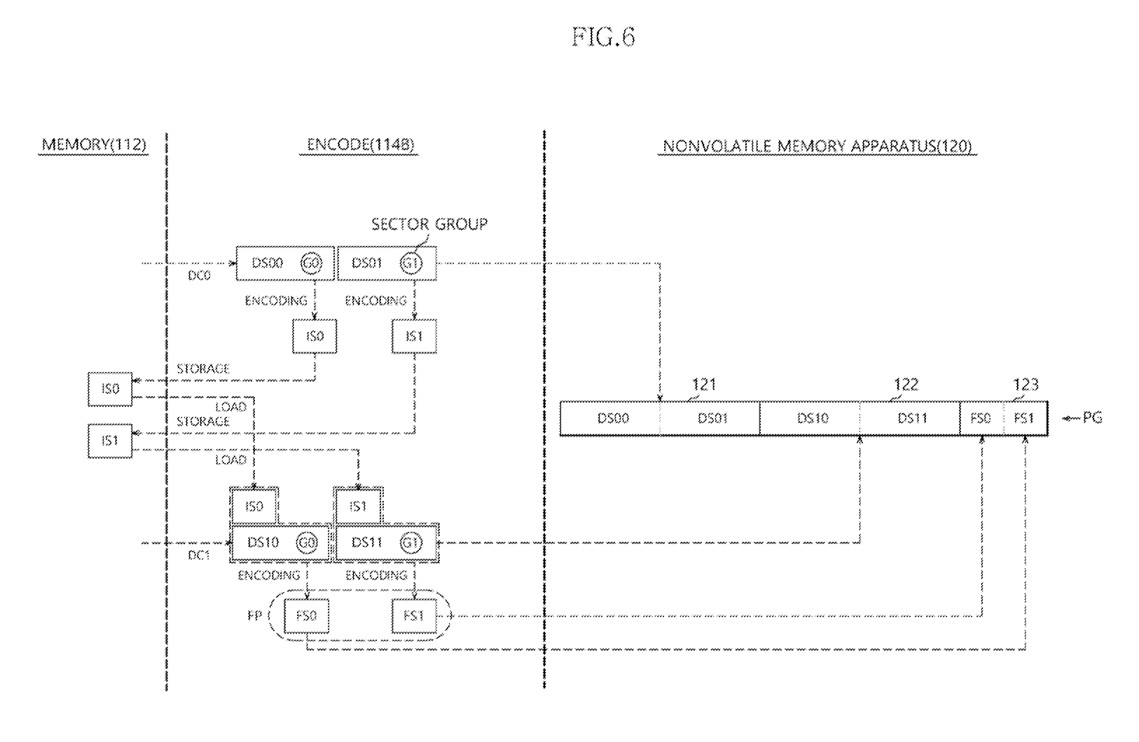

FIG. 6 is a transaction diagram Illustrating an operating method of the data storage device 100 described with reference to FIG. 1. FIG. 6 illustrates the encoder 114B dividing the data chunks DC0 and DC1, which are to be stored in the chunk areas 121 and 122 of the page PG through the partial write operation, into data sectors, and encoding the data chunks DC0 and DC1 to generate the intermediate and final parity sectors IS0 to IS1 and FP0 to FP1, respectively.

The encoder 114B may receive the data chunk DC0 to be stored in the chunk area 121 from the memory 112. The encoder 114B may divide the data chunk DC0 into data sectors DS00 and DS01 respectively belonging to first and second sector groups G0 and G1. The encoder 114B may respectively encode the data sectors DS00 and DS01, thereby generating the intermediate parity sectors IS0 and IS1 according to the first and second sector groups G0 and G1.

The encoded data sectors DS00 and DS01 may be directly stored in the chunk area 121. The intermediate parity sectors IS0 and IS1 may be stored in the memory 112 until the data chunk DC1 to be encoded together with the data chunk DC0 is inputted to the encoder 114B.

Then, the encoder 114B may receive the data chunk DC1 to be stored in the chunk area 122 from the memory 112. The encoder 114B may divide the data chunk DC1 into data sectors DS10 and DS11 respectively belonging to the first and second sector groups G0 and G1. The encoder 114B may respectively encode the data sectors DS10 and DS11 by using the intermediate parity sectors IS0 and IS1 loaded from the memory 112, thereby generating final parity sectors FS0 and FS1 according to the first and second sector groups G0 and G1.

The encoded data sectors DS10 and DS11 may be stored in the chunk area 122. Since there is no other following data chunk to be encoded together with the data chunks DC0 and DC1, the final parity sectors FS0 and FS1 may be stored in the spare area 123 as final parity sectors FP0 and FP1.

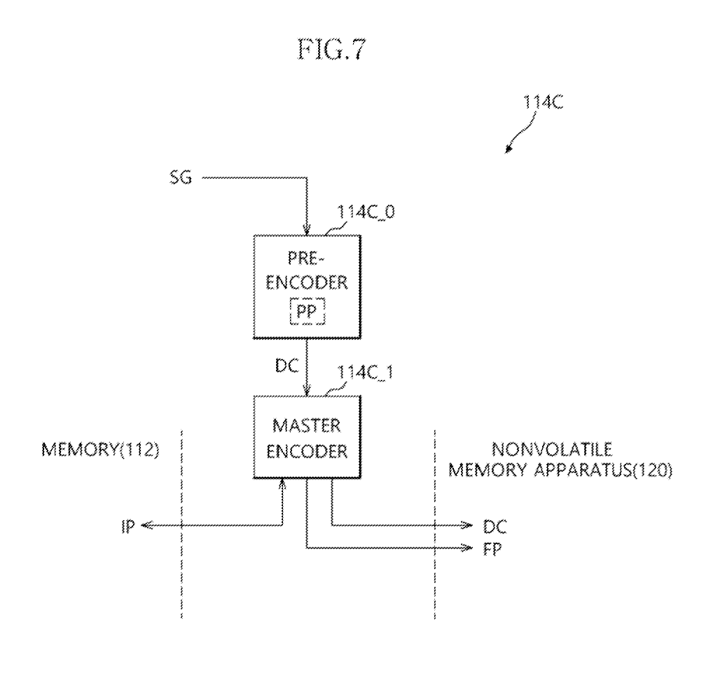

FIG. 7 is a block diagram Illustrating an example of an encoder 114C described with reference to FIG. 1.

The encoder 114C may include a pre-encoder 114C_0 and a master encoder 114C_1.

The pre-encoder 114C_0 may encode a data segment SG to generate pre-parity data PP, and generate a data chunk DC on the basis of the data segment SG and the pre-parity data PP.

The master encoder 114C_1 may encode the data chunk DC to generate the parity data. The parity data may be outputted as intermediate parity data IP or final parity data FP. The master encoder 114C_1 may be the same as the encoder 114A described with reference to FIGS. 3 and 4. Accordingly, a detailed description thereof will be omitted.

According to an embodiment, the pre-encoder 114C_0 and the master encoder 114C_1 may perform encoding operations according to different ECC algorithms. The pre-encoder 114C_0, for example, may encode the data segment SG according to the Turbo-Product Code (TPC) algorithm. The master encoder 114C_1, for example, may encode the data chunk DC according to the Bose-Chaudhri-Hocquenghem (BCH) algorithm.

According to an embodiment, the encoder 114C may include a plurality of pre-encoders respectively corresponding to a plurality of chunk areas included in a single page. In such a case, the plurality of pre-encoders may generate data chunks to be stored in corresponding chunk areas, respectively. When the controller 110 stores data one page at a time, the plurality of pre-encoders may simultaneously generate data chunks to be stored in corresponding chunk areas.

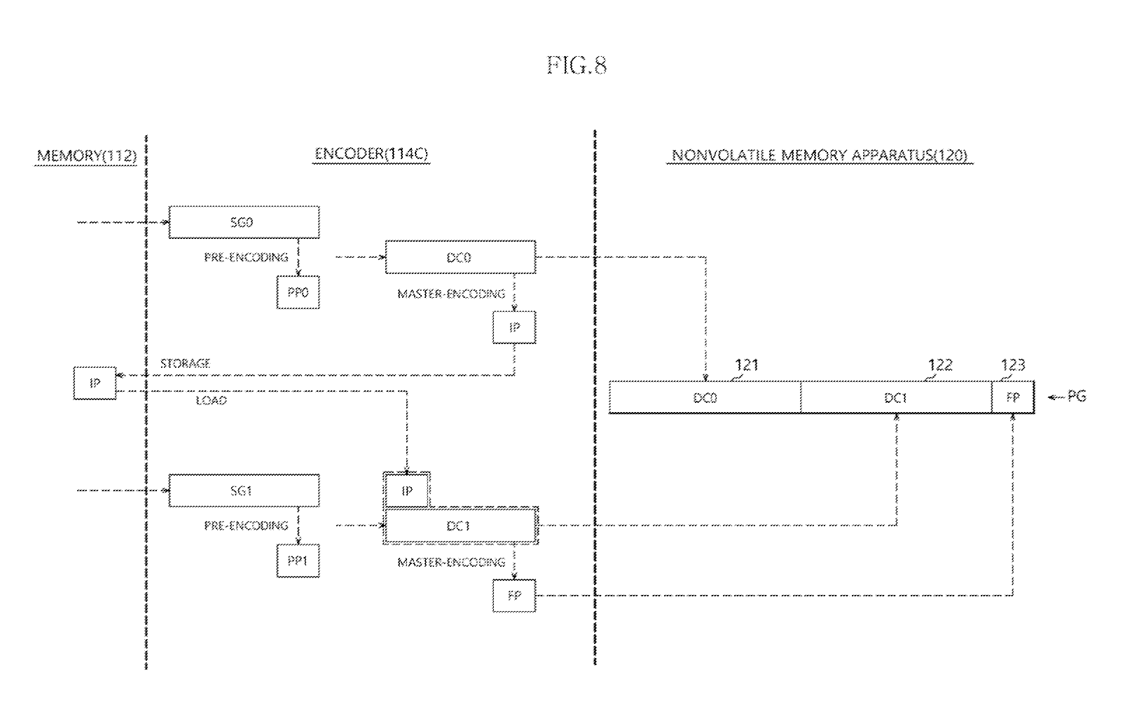

FIG. 8 is a transaction diagram illustrating an operation of the data storage device 100 described with reference to FIG. 1. FIG. 8 illustrates the encoder 114C pre-encoding data segments SG0 and SG1 to generate the data chunks DC0 and DC1, and encoding data chunks DC0 and DC1 to be stored in the chunk areas 121 and 122 of the page PG through the partial write operation thereby generating the intermediate parity data IP and the final parity data FP.

The pre-encoder 114C_0 may receive the data segment SG0 from the memory 112. The pre-encoder 114C_0 may pre-encode the data segment SG0 to generate pre-parity data PP0, and generate the data chunk DC0 on the basis of the data segment SG0 and the pre-parity data PP0. For example, the pre-encoder 114C_0 may add the pre-parity data PP0 to the data segment SG0, thereby generating the data chunk DC0.

The master encoder 114C_1 may receive the data chunk DC0 from the pre-encoder 114C_0. The master encoder 114C_1 may master-encode the data chunk DC0, thereby generating the intermediate parity data IP.

The master-encoded data chunk DC0 may be directly stored in the chunk area 121. The intermediate parity data IP may be stored in the memory 112 until the data chunk DC1 to be master-encoded together with the data chunk DC0 is generated by the pre-encoder 114C_0.

Then, the pre-encoder 114C_0 may receive the data segment SG1 from the memory 112. The pre-encoder 114C_0 may pre-encode the data segment SG1 to generate pre-parity data PP1, and generate the data chunk DC1 on the basis of the data segment SG1 and the pre-parity data PP1. For example, the pre-encoder 114C_0 may add the pre-parity data PP1 to the data segment SG1, thereby generating the data chunk DC1.

The master encoder 114C_1 may receive the data chunk DC1 from the pre-encoder 114C_0. The master encoder 114C_1 may master-encode the data chunk DC1, thereby generating the final parity data FP.

The master-encoded data chunk DC1 may be stored in the chunk area 122. Since there is no other following data chunk to be master-encoded together with the data chunks DC0 and DC1, the final parity data FP may be stored in the spare area 123.

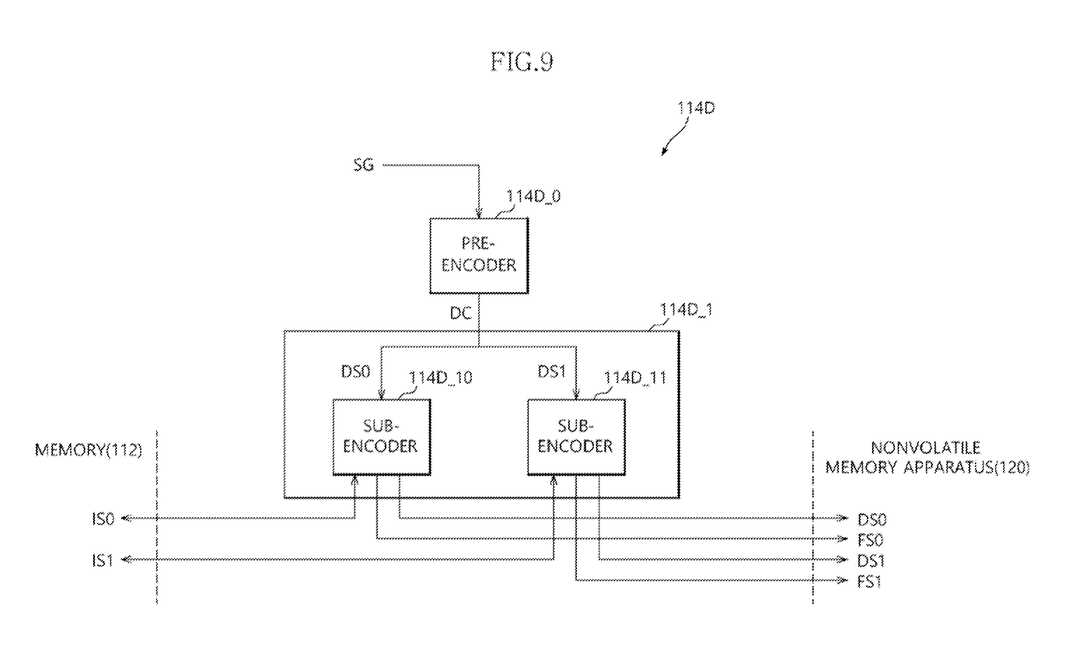

FIG. 9 is a block diagram illustrating an example of an encoder 114D described with reference to FIG. 1.

The encoder 114D may include a pre-encoder 114D_0 and a master encoder 114D_1.

The pre-encoder 114D_0 may be the same as the pre-encoder 114C_0 described with reference to FIGS. 7 and 8. The master encoder 114D_1 may include sub-encoders 114D_10 and 114D_11. The sub-encoders 114D_10 and 114D_11 may be the same as the sub-encoders 114B_0 and 114B_1 described with reference to FIGS. 5 and 6, respectively. Accordingly, a detailed description thereof will be omitted.

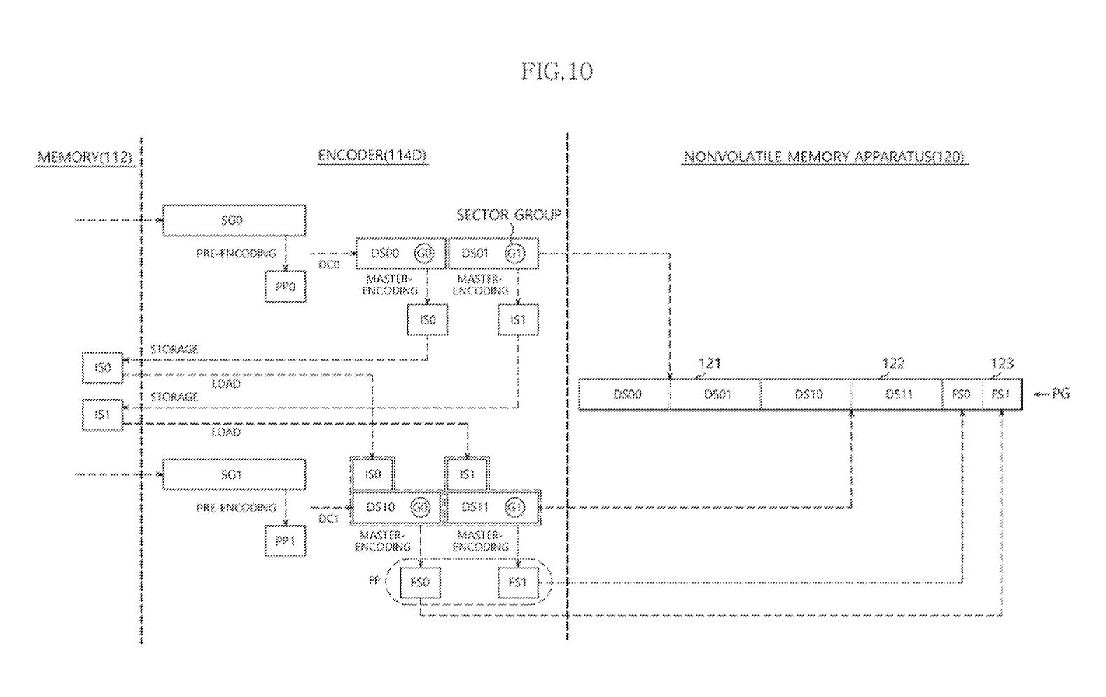

FIG. 10 is a transaction diagram illustrating an operation of the data storage device 100 described with reference to FIG. 1. FIG. 10 illustrates the encoder 114D pre-encoding data segments SG0 and SG1 to generate the data chunks DC0 and DC1, dividing the data chunks DC0 and DC1, which are to be stored in the chunk areas 121 and 122 of the page PG through the partial write operation, into multiple data sectors, and encoding the data chunks DC0 and DC1 to generate the intermediate and final parity sectors IS0 to IS1 and FP0 to FP1, respectively.

The pre-encoder 114D_0 may receive the data segment Jo SG0 from the memory 112. The pre-encoder 114D_0 may pre-encode the data segment SG0 to generate pre-parity data PP0, and generate the data chunk DC0 on the basis of the data segment SG0 and the pre-parity data PP0.

The master encoder 114D_1 may divide the data chunk DC0 into data sectors DS00 and DS01 respectively belonging to first and second sector groups G0 and G1. The encoder 114B may respectively encode the data sectors DS00 and DS01, thereby generating the intermediate parity sectors IS0 and IS1 according to the first and second sector groups G0 and G1.

The master-encoded data sectors DS00 and DS01 may be directly stored in the chunk area 121. The intermediate parity sectors IS0 and IS1 may be stored in the memory 112 until the data chunk DC1 to be encoded together with the data chunk DC0 is generated by the pre-encoder 114D_0.

Then, the pre-encoder 114D_0 may receive the data segment SG1 from the memory 112. The pre-encoder 114D_0 may pre-encode the data segment SG1 to generate pre-parity data PP1, and generate the data chunk DC1 on the basis of the data segment SG1 and the pre-parity data PP1.

The master encoder 114D_1 may divide the data chunk DC1 into data sectors DS10 and DS11 respectively belonging to the first and second sector groups G0 and G1. The master encoder 114D_1 may respectively master-encode the data sectors DS10 and DS11 by using the intermediate parity sectors IS0 and IS1 loaded from the memory 112, thereby generating the final parity sectors FS0 and FS1 according to the first and second sector groups G0 and G1.

The master-encoded data sectors DS10 and DS11 may be stored in the chunk area 122. Since there is no other following data chunk to be encoded together with the data chunks DC0 and DC1, the final parity sectors FS0 and FS1 may be stored in the spare area 123 as final parity sectors FP0 and FP1.

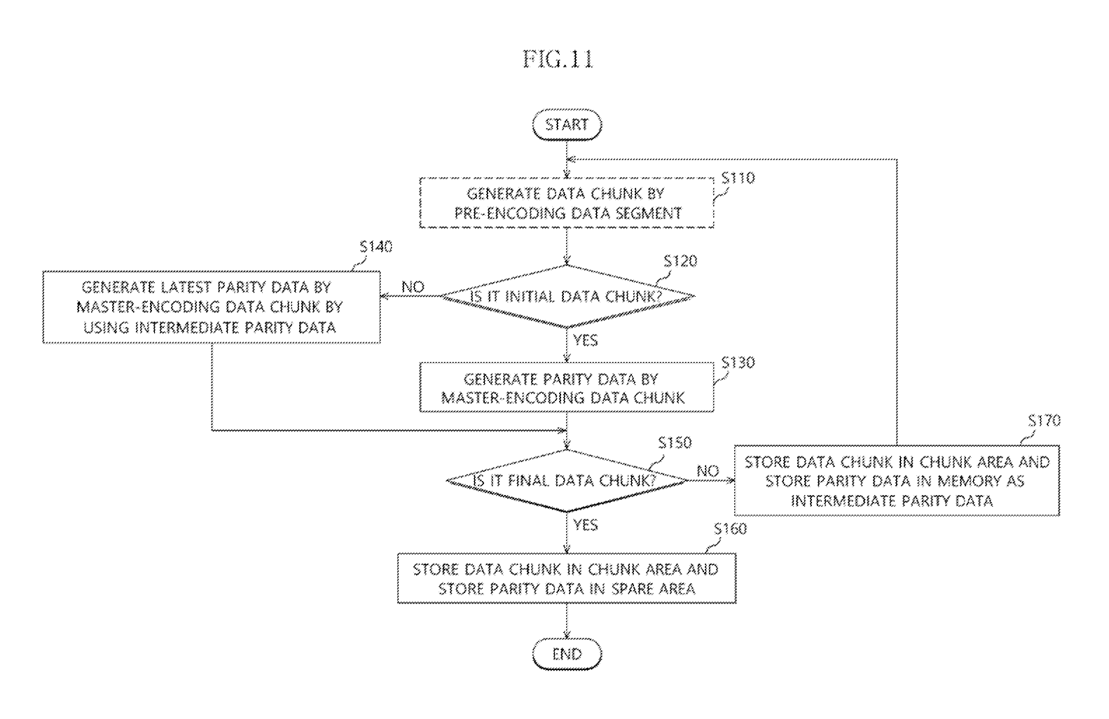

FIG. 11 is a flowchart illustrating an operation of the data storage device 110 according to an embodiment.

In step S110, the controller 110 may pre-encode a data segment thereby generating a data chunk to be partially stored in a plurality of chunk areas included in a page of the nonvolatile memory apparatus 120. According to an embodiment, step S110 may be omitted and the controller 110 may receive the data chunk from an external device.

In step S120, the controller 110 may determine whether the data chunk is an initial data chunk of the page PG. When it is determined that the data chunk is the initial data chunk of the page PG, the procedure may proceed to step S130. When it is determined that the data chunk is not the initial data chunk of the page PG, the procedure may proceed to step S140.

In step S130, the controller 110 may master-encoder the data chunk to generate an intermediate parity data. According to an embodiment, the controller 110 may divide the data chunk into a plurality of data sectors respectively belonging to sector groups, and respectively perform master encoding on the data sectors according to the sector groups, thereby generating intermediate parity sectors as the intermediate parity data.

In step S140, the controller 110 may encode the data chunk by using the intermediate parity data stored in the memory 112, thereby updating the intermediate parity data. According to an embodiment, the controller 110 may respectively perform master-encoding by using the intermediate parity sectors stored in the memory 112 according to the sector groups, thereby updating the intermediate parity sectors as the intermediate parity data.

In step S150, the controller 110 may determine whether the data chunk is a final data chunk of the page PG. When it is determined that the data chunk is the final data chunk of the page PG, the procedure may proceed to step S160. When it is determined that the data chunk is not the final data chunk of the page PG, the procedure may proceed to step S170.

In step S160, the controller 110 may store the master-encoded data chunk in the chunk area of the nonvolatile memory apparatus 120, and store the currently generated (S130) or updated (S140) intermediate parity data in the spare area of the nonvolatile memory apparatus 120 as the final parity data.

In step S170, the controller 110 may store the master-encoded data chunk in the chunk area of the nonvolatile memory apparatus 120, and store the currently generated (S130) or updated (S140) intermediate parity data in the memory 112.

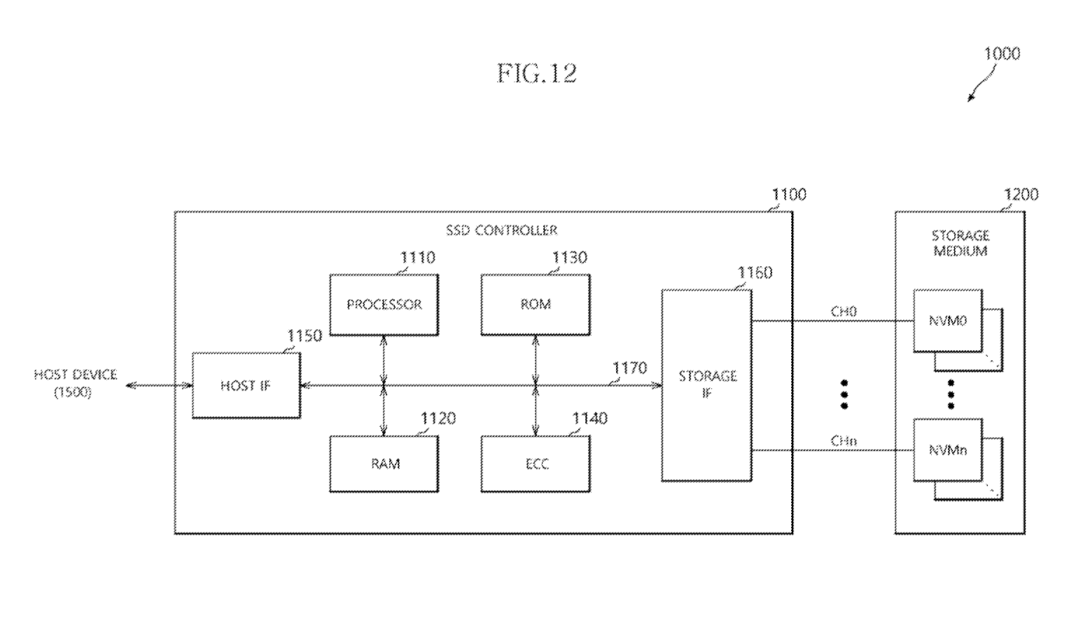

FIG. 12 is a block diagram illustrating an SSD 1000 according to an embodiment.

The SSD 1000 may include an SSD controller 1100 and a storage medium 1200.

The SSD controller 1100 may control data exchange between a host device 1500 and the storage medium 1200. The SSD controller 1100 may include a processor 1110, a RAM 1120, a ROM 1130, an ECC unit 1140, a host interface unit 1150, and a storage interface unit 1160.

The processor 1110 may control general operation of the SSD controller 1100. The processor 1110 may store data in the storage medium 1200 and read the stored data from the storage medium 1200 according to a request of the host device 1500. The processor 1110 may control an internal operation of the SSD 1000 such as a merge operation and a wear leveling operation in order to efficiently manage the storage medium 1200.

Furthermore, the processor 1110 may operate similarly to the processor 111 illustrated in FIG. 1. The processor 1110 may control data chunks discontinuously stored in the storage medium 1200 to be encoded together. Each of the data chunks may be data to be partially stored in one page included in the storage medium 1200.

The RAM 1120 may store programs and program data used by the processor 1110. The RAM 1120 may temporarily store data transmitted from the host interface unit 1150 before the data is transferred to the storage medium 1200, and may temporarily store data transmitted from the medium 1200 before the data is transferred to the host interface unit 1150. As with the memory 112 illustrated in FIG. 1, the RAM 1120 may store intermediate parity data generated with respect to a data chunk to be stored in the storage medium 1200.

The ROM 1130 may store program codes read by the processor 1110. The program codes may include commands processed by the processor 1110 when the processor 1110 controls internal units of the SSD controller 1100.

The ECC unit 1140 may encode data to be stored in the storage medium 1200 and decode data read from the storage medium 1200. The ECC unit 1140 may detect and correct an error generated in data according to the ECC algorithm. As with the encoder 114 illustrated in FIG. 1, the ECC unit 1140 may encode a plurality of data chunks, which are discontinuously transmitted, together by using the intermediate parity data loaded from the RAM 1120.

The host interface unit 1150 may exchange requests, data and the like with the host device 1500.

The storage interface unit 1160 may transmit control signals and data to the storage medium 1200. The storage interface unit 1160 may receive data from the storage medium 1200. The storage interface unit 1160 may be coupled to the storage medium 1200 through a plurality of channels CH0 to CHn.

The storage medium 1200 may include a plurality of nonvolatile memory apparatuses NVM0 to NVMn. Each of the plurality of nonvolatile memory apparatuses NVM0 to NVMn may perform a write operation and a read operation under the control of the SSD controller 1100. As with the nonvolatile memory apparatus 120 illustrated in FIG. 1, each of the plurality of nonvolatile memory apparatuses NVM0 to NVMn may independently perform a partial write operation with respect to each of the chunk areas included in the page.

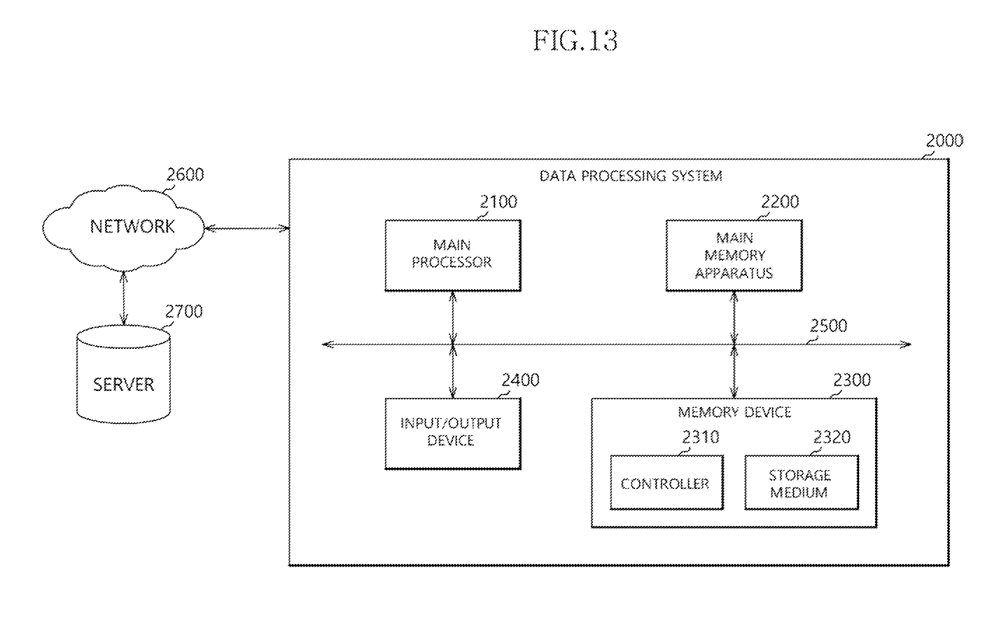

FIG. 13 is a block diagram illustrating a data processing system 2000 to which the data storage device 1000 according to the embodiment has been applied.

The data processing system 2000 may include a computer, a laptop, a netbook, a smart phone, a digital TV, a digital camera, a navigation and the like. The data processing system 2000 may include a main processor 2100, a main memory apparatus 2200, a memory device 2300, and an input/output device 2400. The internal units of the data processing system 2000 may exchange data and control signals through a system bus 2500.

The main processor 2100 may control general operation of the data processing system 2000. The main processor 2100, for example, may be a central processing device such as a microprocessor. The main processor 2100 may execute software such as an operating system, applications, and device drivers on the main memory apparatus 2200.

The main memory apparatus 2200 may store programs and program data used by the main processor 2100. The main memory apparatus 2200 may temporarily store data to be transmitted to the memory device 2300 and the input/output device 2400.

The memory device 2300 may include a memory controller 2310 and a storage medium 2320. The memory controller 2310 may be configured similarly to the controller 110 of FIG. 1. The memory controller 2310 may encode a plurality of data chunks, which are to discontinuously stored in the storage medium 2320, together.

The input/output device 2400 may include a keyboard, a scanner, a touchscreen, a mouse and the like, which may exchange information with a user such as reception of commands for controlling the data processing system 2000 from the user or providing of processed results to the user.

According to an embodiment, the data processing system 2000 may communicate with at least one server 2700 through a network 2600 such as a Local Area Network (LAN), a Wide Area Network (WAN), and a wireless network. The data processing system 2000 may include a network interface unit (not illustrated) in order to be coupled to the network 2600.

While certain embodiments have been described above, it will be understood to those skilled in the art that the embodiments are only examples. Accordingly, the data storage device and the operating method thereof described herein should not be limited based on the described embodiments. Rather, the data storage device and the operating method thereof described herein should only be limited in light of the claims that follow when taken in conjunction with the above description and accompanying drawings.

What is claimed is:

1. A data storage device comprising:
a nonvolatile memory apparatus including a page including a plurality of chunk areas respectively corresponding to a plurality of data chunks; and
a controller including a memory, and suitable for generating parity data by independently encoding a data chunk, storing the data chunk in a chunk area of the page and storing the parity data in the memory as intermediate parity data.

2. The data storage device of claim 1, wherein the controller further updates the intermediate parity data by encoding a current data chunk by using the intermediate parity data currently stored in the memory.

3. The data storage device of claim 2, wherein, when the current data chunk is a final data chunk of the page, the controller further stores the currently updated intermediate parity data in the page as final parity data.

4. The data storage device of claim 1, wherein the controller controls the nonvolatile memory apparatus to independently store each of the data chunks in a corresponding chunk area through a partial write operation.

5. The data storage device of claim 1,
wherein each of the data chunks includes a plurality of data sectors respectively belonging to a plurality of sector groups, and
wherein the parity data includes a plurality of parity sectors respectively corresponding to the data sectors according to the sector groups.

6. The data storage device of claim 5, wherein the controller further updates the parity sectors by encoding the data sectors in a current data chunk by using the parity sectors currently stored in the memory.

7. The data storage device of claim 1, wherein the controller further generates the data chunks by pre-encoding a plurality of data segments.

8. The data storage device of claim 7, wherein the controller further updates the intermediate parity data by encoding a current data chunk by using the intermediate parity data currently stored in the memory.

9. The data storage device of claim 8, wherein, when the current data chunk is a final data chunk of the page, the controller further stores the currently updated intermediate parity data in the page as final parity data.

10. The data storage device of claim 7,
wherein each of the data chunks includes a plurality of data sectors respectively belonging to a plurality of sector groups, and
wherein the parity data includes a plurality of parity sectors respectively corresponding to the data sectors according to the sector groups.

11. An operating method of a data storage device including a page including a plurality of chunk areas respectively corresponding to a plurality of data chunks, the operating method comprising:
generating parity data by independently encoding a data chunk;
storing the data chunk in one of the chunk areas of the page; and
storing the parity data in a memory as intermediate parity data.

12. The operating method of claim 11, further comprising updating the intermediate parity data by encoding a current data chunk by using the intermediate parity data currently stored in the memory.

13. The operating method of claim 12, further comprising storing the currently updated intermediate parity data in the page as final parity data when the current data chunk is a final data chunk of the page.

14. The operating method of claim 11, wherein the storing of the data chunk is performed by independently storing each of the data chunks in a corresponding chunk area through a partial write operation.

15. The operating method of claim 11,
wherein each of the data chunks includes a plurality of data sectors respectively belonging to a plurality of sector groups, and
wherein the parity data includes a plurality of parity sectors respectively corresponding to the data sectors according to the sector groups.

16. The operating method of claim 15, further comprising updating the parity sectors by encoding the data sectors in a current data chunk by using the parity sectors currently stored in the memory.

17. The operating method of claim 11, further comprising generating the data chunks by pre-encoding a plurality of data segments.

18. The operating method of claim 17, further comprising updating the intermediate parity data by encoding a current data chunk by using the intermediate parity data currently stored in the memory.

19. The operating method of claim 18, further comprising storing the currently updated intermediate parity data in the page as final parity data when the current data chunk is a final data chunk of the page.

20. The operating method of claim 17,
wherein each of the data chunks includes a plurality of data sectors respectively belonging to a plurality of sector groups, and
wherein the parity data includes a plurality of parity sectors respectively corresponding to the data sectors according to the sector groups.
